(19) United States
(12) Patent Application Publication
(10) Pub. No.: US 2013/0029681 A1
(43) Pub. Date: Jan. 31, 2013

(54) DEVICES, METHODS, AND APPARATUSES FOR INFERRING A POSITION OF A MOBILE DEVICE

(71) Applicant: Leonard Henry Grokop, San Diego, CA (US)

(72) Inventor: Leonard Henry Grokop, San Diego, CA (US)

(73) Assignee: QUALCOMM Incorporated, San Diego, CA (US)

(21) Appl. No.: 13/362,485

(22) Filed: Jan. 31, 2012

Related U.S. Application Data
(60) Provisional application No. 61/470,001, filed on Mar. 31, 2011.

(51) Int. Cl. H04W 24/00

(52) U.S. Cl. 455/456.1

(57) ABSTRACT

Components, methods, and apparatuses are provided that may be used to characterize a spectral envelope of at least one signal received from one or more inertial sensors of a mobile device co-located with a user engaged in an activity and to infer a position of the mobile device with respect to the user engaged in an activity based, at least in part, on the characterization of the spectral envelope.

### CROSS-REFERENCE TO RELATED APPLICATION

The present application claims priority to U.S. provisional application No. 61/470,001 entitled “Classification of User Activity Using Spectral Envelop of Sensor Signals,” filed Mar. 31, 2011, which is hereby incorporated by reference in its entirety.

### BACKGROUND

1. Field

The subject matter disclosed herein relates to detecting at least a position state classification of a mobile device with respect to a user.

2. Information

Many mobile communication devices, such as smartphones, include an inertial sensor, such as an accelerometer, that may be used to detect motion of the device. These movements may be useful in detecting the device's orientation so that a display may be properly oriented, for example in a portrait or a landscape mode, when displaying information to a user. In another example, a gaming application performed by way of a smartphone may rely on movements detected by one or more accelerometers so that a feature of the game may be controlled. In other examples, a gesturing movement detected by an accelerometer may allow a user to scroll a map, navigate a menu, or control other aspects of the device's operation.

Though useful in assisting with simple user interface tasks, output “traces” from an accelerometer have been limited from providing more sophisticated and meaningful assistance to mobile device users. For example, if a mobile device can detect that a user is engaged in a strenuous activity, it may be useful to direct incoming telephone calls immediately to voicemail so as not to distract the user. In another example, if it can be detected that a mobile device is in a user's purse or pocket, it may be advantageous to disable a display so as not to waste battery resources.

Detection of some types of movement has involved the use of thresholding so that peak acceleration may be estimated. However, estimated peak acceleration may provide only very limited information concerning the activity of the user and the mobile device. By examining more features of an accelerometer trace, a wider range of motion states and device positions with respect to a user of a mobile device can be discerned. In turn, this may enable a service provider to better adapt a mobile device's behavior to match users' individual needs.

### SUMMARY

In particular implementations, a method comprises characterizing a spectral envelope of at least one signal received from one or more inertial sensors of a mobile device co-located with a user and inferring a position of the mobile device with respect to the user engaged in an activity based, at least in part, on the characterization of the spectral envelope.

In another implementation, an apparatus comprises means for measuring acceleration of a mobile device, means for characterizing a spectral envelope of at least one signal received from the means for measuring acceleration, and means for inferring a position of the mobile device with respect to the user engaged in an activity based, at least in part, on the characterization of the spectral envelope.

In another implementation, an article comprises a non-transitory storage medium comprising machine-readable instructions stored thereon which are executable by a processor of a mobile device to characterize a spectral envelope of at least one signal received from one or more inertial sensors of a mobile device and to infer a position of the mobile device with respect to the user engaged in an activity based, at least in part, on the characterization of the spectral envelope.

In another implementation, a mobile device comprises one or more sensors for measuring acceleration of the mobile device and comprises one or more processors that characterizes a spectral envelope of at least one signal received from the one or more inertial sensors. The mobile device may further infer a position of the mobile device with respect to the user engaged in an activity based, at least in part, on the characterizing of the spectral envelope.

### BRIEF DESCRIPTION OF DRAWINGS

Non-limiting and non-exhaustive aspects are described with reference to the following figures, wherein like reference numerals refer to like parts throughout the various figures.

FIG. 1 is an example coordinate system that may be applied to a mobile device according to an implementation.

FIG. 2 shows a user walking with a mobile device in hand along with a plot of acceleration of a mobile device as a function of time according to an implementation.

FIG. 3 shows a user walking with a mobile device in a hip pocket along with a plot of acceleration of the mobile device as a function of time according to an implementation.

FIG. 4 is a diagram of a process for characterizing a spectral envelope of a sensor signal according to an implementation.

FIG. 5 is a plot illustrating the decision regions that are formed as a result of training a classifier according to an implementation.

FIG. 6 is a schematic diagram illustrating an example-computing environment associated with a mobile device according to an implementation.

FIG. 7 is a flow chart illustrating a process of inferring a position of a mobile device with respect to a user engaged in an activity according to an implementation.

### DETAILED DESCRIPTION

Devices, methods, and apparatuses are provided that may be implemented in various mobile devices to infer at least a position state of a mobile device with respect to a user engaged in an activity. In implementations, signal-processing algorithms may be applied to one or more output traces of an inertial sensor, such as an accelerometer, included within the mobile device.

In a particular implementation, a classifier may infer an activity state of a mobile device user engaged in an activity based, at least in part, on signals received from inertial sensors, such as one or more accelerometers, located on the mobile device. In particular examples, signals from one or more inertial sensors may be processed to compute or extract “features” that may be indicative or suggestive of a particular activity state of a mobile device user. In addition, features extracted from one or more inertial sensors may be processed to infer a position of the mobile device with respect to the user engaged in an activity.

Features computed from inertial sensors may be applied to a classification engine to infer a particular activity, such as standing versus sitting, manipulating the mobile device, walking, running, driving, riding a bicycle, etc. In one implementation, a classification engine may apply pattern recognition to infer a particular activity from computed or extracted features and to infer a position of a mobile device with respect to a user engaged in an activity.

In a particular implementation, additional features may be obtained or extracted from a sensor signal for use in inferring an activity of a user co-located with a mobile device while the user is engaged in an activity. For example, by processing a signal from an inertial sensor as a waveform, a “spectral envelope” may be characterized. The characterization of the spectral envelope may be applied in infer an activity of the user and/or infer a position of the mobile device with respect to the user engaged in an activity. In this context, a user may be co-located with a mobile device by, for example, holding the mobile device, wearing the mobile device on his or her wrist or upper arm, having the mobile device in his/her pocket, being in an immediate proximate environment with the mobile device, just to name a few examples.

In particular examples, a spectral envelope may represent spectral properties of a signal in a frequency-amplitude plane derived from a Fourier magnitude spectrum. As discussed below, certain techniques to characterize a spectral envelope of signals used in speech processing, such as Cepstral filtering may also be applied in characterizing features of signals generated by inertial sensors.

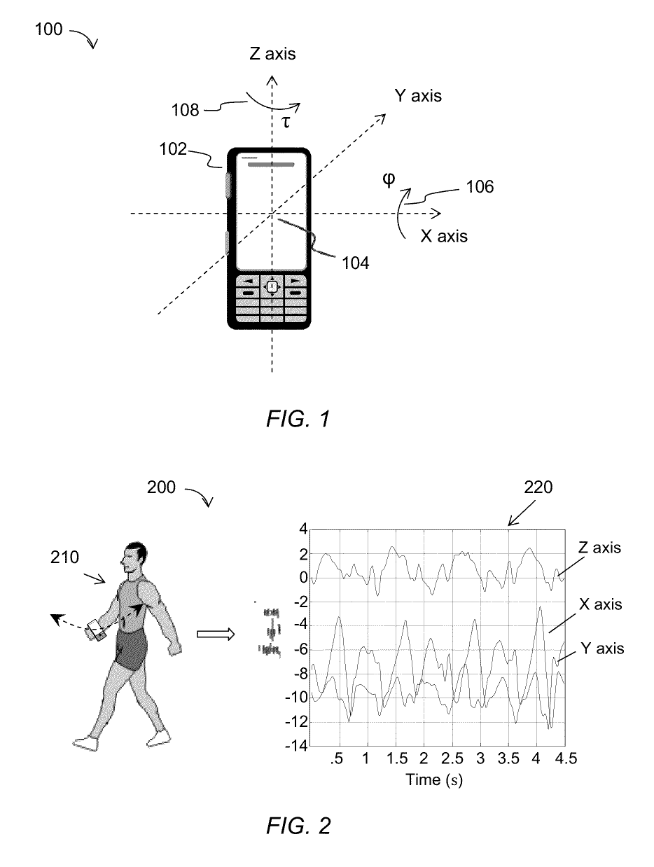

FIG. 1 illustrates an example coordinate system 100 that may be used, in whole or in part, to facilitate or support an inference of an activity classification in connection with a user of a mobile device, such as a mobile device 102, for example, while the user is engaged in an activity using accelerometer output traces according to an implementation. It should be understood, however that an accelerometer is merely one example of an inertial sensor from which a user activity may be classified, and claimed subject matter is not limited in this respect. For example, signals from other types of sensors such as other inertial sensors (e.g., gyroscopes, magnetometers, etc.) pressure sensors, ambient light sensors, imaging sensors, temperature sensors, just to name a few examples, may be processed for classifying an activity of a user co-located with a mobile device. As illustrated, example coordinate system 100 may comprise, for example, a three-dimensional Cartesian coordinate system, though claimed subject matter is not so limited. Herein, the term “trace” refers to time dependent sensor output information and does not require continuous output information to be obtained/displayed in trace form.

In the illustration of FIG. 1, motion of mobile device 102 representing, for example, acceleration vibration may be detected or measured, at least in part, with reference to three linear dimensions or axes X, Y, and Z relative to the origin 104 of example coordinate system 100. It should be appreciated that example coordinate system 100 may or may not be aligned with the body of mobile device 102. It should also be noted that in certain implementations, a non-Cartesian coordinate system, such as a cylindrical or a spherical coordinate system, or other coordinate system that defines the necessary number of dimensions may be used.

As also illustrated in FIG. 1, rotational motion of mobile device 102, for example, may be detected or measured, at least in part, with reference to one or two dimensions. For example, in one particular implementation, rotational motion of mobile device 102 may be detected or measured in terms of coordinates (φ, τ), where phi (φ) represents pitch or rotation about an X-axis, as illustrated generally by an arrow at 106, and tau (τ) represents roll or rotation about a Z-axis, as illustrated generally by an arrow 108. Accordingly, in an implementation, a 3-D accelerometer (e.g. an accelerometer capable of measuring acceleration in three dimensions) may detect or measure, at least in part, a level of acceleration vibration as well as a change with respect to gravity in roll or in pitch dimensions, for example, thus providing five dimensions of observability (X, Y, Z, φ, τ). It should be understood, however, that these are merely examples of various motions that may be detected or measured with reference to example coordinate system 100, and that claimed subject matter is not limited to these particular motions or to the above-identified coordinate systems.

FIG. 2 (200) shows a user walking with a mobile device in hand along with a plot showing an output trace of an accelerometer on a mobile device as a function of time according to an implementation. In FIG. 2, user 210 is shown with a mobile device in his right hand, walking with a typical gait. Plot 220, shown to the right of user 210, results, at least in part, from output signals generated by a three-axis accelerometer carried by user 210.

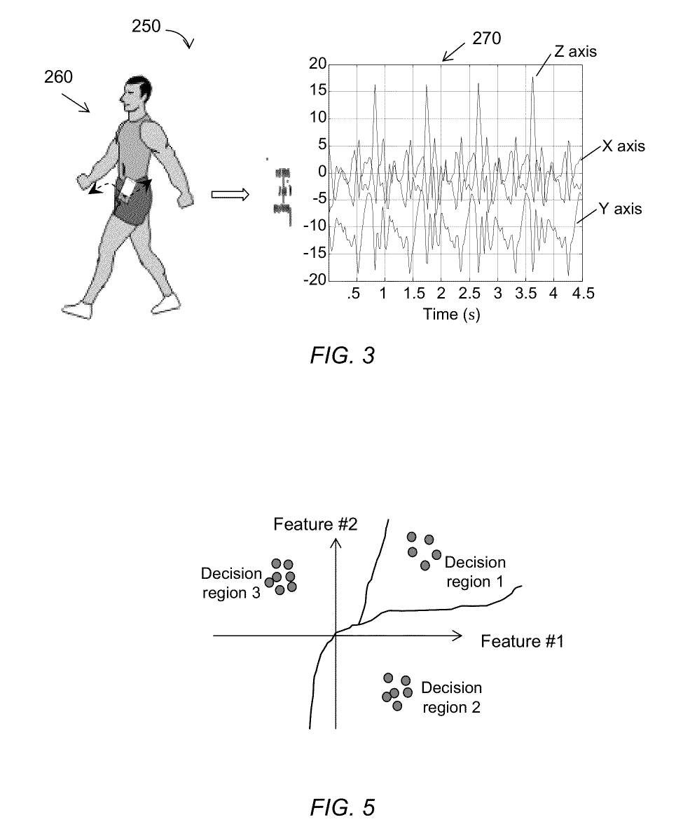

FIG. 3 (250) shows a user walking with a mobile device in hand along with a plot showing an output trace of an accelerometer on a mobile device as a function of time according to an implementation. In FIG. 3, user 260 is shown walking at an average gait with a mobile device within the user's hip pocket. Plot 270, which is shown to the right of a user 260, results, at least in part, from output signals generated by a three-axis accelerometer within the mobile device.

Thus, as shown in the implementations of FIGS. 2 and 3, a mobile device positioned in a user's hip pocket while the user is walking may result in an accelerometer trace that is different from an accelerometer trace that may result from the user carrying the mobile device in his or her hand. In this example, as shown in plot 270, a mobile device positioned in the user's pocket may undergo distinct and periodic acceleration in the vertical (±Z) direction as the user walks but may undergo very little acceleration in the ±X or ±Y directions. Accordingly, in an example, inferring that said user is walking with said mobile device in said user's pocket may be based, at least in part, on detecting acceleration peaks in a first direction, which may be greater than acceleration peaks in second and third directions

In contrast, a mobile device positioned in a user's hand while the user walks, as shown in plot 220, may undergo greater acceleration in the vertical (±Z) direction but may undergo increased acceleration in the ±X or ±Y directions, for example. Accordingly, in an example, inferring that the user is walking with the mobile device in the user's hand may be based, at least in part, on detecting acceleration of the mobile device in the ±Z direction, which may be greater than acceleration in ±X or ±Y directions.

Following the above discussion, a 3-D accelerometer may detect or measure accelerations in three-dimensional space due to various movements, for example, in response to activity of a user co-located with the device. Typically, although not necessarily, acceleration vibrations may be associated with one or more of various candidate activity classes, such as, for example, with a moving vehicle, such as an automobile, motorcycle, bicycle, bus, or train resulting, at least in part, from vibrations generated by engines, wheels, and unevenness in a road, etc. Acceleration vibrations may also be associated with candidate position states of a mobile device with respect to a user while the user is engaged in an activity such as walking or running, while a mobile device is carried in a user's hand, fastened to a user's wrist or arm, placed in a user's shirt or coat pocket, etc. Acceleration vibrations may also be associated with candidate position states while the user is engaged in an activity while a mobile device is carried in a user's purse, backpack, carry-on bag, holster attached to a user's belt or clothing, etc. Candidate position states may include being in any other type of bag, such as a suitcase or briefcase carried by or wheeled by said user. It should be noted that these are merely examples of candidate position states of a mobile device with respect to a user, and claimed subject matter is not so limited.

In a particular implementation, a classifier may infer a particular activity state of a user co-located with a mobile device while the user is engaged in an activity based, at least in part on signals received one or more inertial sensors on the mobile device such as accelerometers. Here, an accelerometer may generate one or more output traces (accelerometer output over time), which may be indicative of acceleration along a particular linear dimension (e.g., along X, Y, or Z axes). As discussed below, accelerometer traces may be processed to compute a measurement of a likelihood that a user is performing a particular activity such as sitting, standing, manipulating the device, walking, jogging, riding a bicycle, running, eating, and so forth. Accelerometer traces may also be processed to infer a position state of the mobile device.

As pointed out above, an activity of a user co-located with a mobile device may be inferred based, at least in part, on a characterization of a spectral envelope of an inertial sensor trace. In a particular implementation, one or more of the following features may be extracted from an inertial sensor signal to characterize a spectral envelope of the sensor signal:

1. Cepstral Coefficients (CCs);

2. Mel-Frequency Cepstral Coefficients (MFCCs);

3. delta Cepstral Coefficients (dCCs);

4. delta Mel-Frequency Cepstral Coefficients (dMFCCs);

5. accel Cepstral Coefficients (d2CCs);

6. accel Mel-Frequency Cepstral Coefficients (d2MFCCs);

7. Linear Prediction Coefficients (LPCs);

8. delta Linear Prediction coefficients (dLPCs); and

9. accel Linear Prediction coefficients (dLPCs).

It should be understood, however, that these are merely examples of features that may be extracted from a signal to characterize a spectral envelope (e.g., for use in classifying an activity of a user co-located with a mobile device and/or a position of the mobile device with respect to the user). Claimed subject matter is not limited in this respect.

Regarding extraction of features to characterize a spectral envelope of an inertial sensor output, CCs or MFCCs may provide a parameterization of a spectral envelope of a waveform. Thus CCs or MFCCs may be useful in distinguishing waveforms arising from different types of motions, such as a user's walk or gait, with a mobile device positioned at different locations with respect to the user. In an implementation, CCs may be used to extract features characterized from an inertial sensor signal in which equal emphasis (i.e. weight) is applied to frequency bands of interest. In other implementations, such as may be used in MFCC feature extraction, lower frequency signals may be emphasized while higher frequency signals are deemphasized. Note, as with the term “trace,” the term “waveform” refers to the output of the sensor that need not be continuous/displayed; the spectral envelope information can be determined from continuous or discrete output of one or more motion sensors.

In an implementation, delta CCs may be used to enhance the performance of CCs by considering velocity (e.g., rate of change with respect to time) of each CC across overlapping windows in addition to static CCs. Accel CCs may further enhance the performance of CCs by additionally considering an acceleration of one or more static CCs across overlapping windows (e.g., rate of change of velocity with respect to time).

In implementations, parameters for delta MFCCs and accel MFCCs may be applied to increase accuracy in computing CCs from an inertial sensor output signals. For example, to apply delta and accel filtering, static MFCCs may be calculated by way of pre-emphasis filtering of frequency bands of interest from the inertial sensor signal. Delta and accel filtering may then be performed on calculated MFCCs to observe velocity and acceleration (as a function of time) of one or more MFCCs.

In implementations, linear prediction coefficients (LPCs) may be used to characterize a spectral envelope if an underlying inertial sensor signal is generated by an all-pole autoregressive process. In an implementation, an LPC may model an inertial sensor's output signal at a particular point in time as an approximate linear combination of previous output signal samples. In an example, an error signal may be added to a set of coefficients that describe the output signals during one or more data windows.

In an implementation, a one-to-one mapping may exist from LPCs to MFCCs. Delta LPCs may enhance the performance of LPCs by additionally considering a velocity (e.g., rate of change as a function of time) of each coefficient across overlapping windows. Accel LPCs may further enhance the performance of LPCs by additionally considering an acceleration of each coefficient across overlapping windows (e.g., rate of change of velocity as a function of time).

In an alternative implementation, other features may be extracted from an inertial sensor signal for use in characterizing an activity of a user collocated with a mobile device (e.g., in lieu of or in combination with a characterization of a spectral envelope). These may include:

1. Pitch;

2. Spectral Entropy;

3. Zero Crossing Rate (ZCR);

4. Spectral Centroid (SC)

5. Bandwidth (BW)

6. Band Energies (BEs);

7. Spectral Flux (SF); and

8. Spectral Roll-off (SR).

In an implementation, pitch, which may define the fundamental frequency of a periodic motion, may be measured from an inertial sensor signal. A measurement of pitch may be useful, for example, in differentiating between or among activities having similar motions that occur at different rates, such as, for example, jogging vs. running, strolling vs. a brisk walk, and so forth.

In an implementation, spectral entropy, which may correspond to a short-duration frequency spectrum of an inertial sensor signal if normalized and viewed as a probability distribution, may be measured. For example, a measurement of spectral entropy may enable parameterization of a degree of periodicity of a signal. In an example, lower spectral entropy, calculated from an accelerometer trace, may indicate that the user is engaged in a periodic activity such as walking, jogging, riding a bicycle, and so forth. Higher spectral entropy, on the other hand, may be an indicator that the user is engaged in an aperiodic activity class such as manipulating the device or driving an automobile on an uneven road.

In an implementation, a zero crossing rate, which may describe the number of times per second an inertial sensor signal crosses its mean value in a certain time window, may be measured. Measurement of a zero crossing rate may be useful in differentiating between motions or device positions with respect to a user that produce inertial sensor signals that fluctuate at different rates, such as walking, which may be indicated by slower fluctuations between positive and negative values vs. running, which may be indicated by more rapid fluctuations between positive and negative values.

In an implementation, a spectral centroid, which may represent a mean frequency of a short-duration frequency spectrum of an inertial sensor signal, may be measured. Subband spectral centroids may found by applying a filterbank to the power spectrum of the inertial sensor signal, and then calculating the first moment (or centroid) for each subband. The signal frequency range may then be partitioned into a number of bins. A corresponding bin for each subband may be computed and incremented by one. Cepstral coefficients may then be computed using a discrete cosine transform of a resulting histogram.

In an implementation, a bandwidth, which may be represented as a standard deviation of the short time frequency spectrum of an inertial sensor signal may be measured. In an example, the bandwidth of an inertial sensor signal may be used to complement one or more other measurements, such as those described herein. In an implementation, band energies, which may be descriptive of energies in different frequency bands of a short duration frequency spectrum of an inertial sensor signal, may be measured.

In various implementations, measurements of spectral centroid, bandwidth and/or band energies may be useful, for example, in differentiating between or among motions or device positions with respect to a user that produce inertial sensor output signals, which may indicate energy concentrations in different portions of a frequency spectrum (e.g., high frequency activities vs. low frequency activities). In some implementations, these additional measurements, made in conjunction with other measurements may be used to increase a probability of a correct activity detection based on an inertial sensor signal.

In an implementation, spectral flux, which may be the average of the difference between the short time frequency spectra across two consecutive windows of an inertial sensor signal, may be measured. Measurement of spectral flux may be used, for example, in characterizing the speed at which a particular periodic behavior is changing (e.g., in characterizing an aerobic activity in which an activity level may change significantly in a short time).

In an implementation, spectral roll-off, which may be the frequency below which a certain fraction of the signal energy resides, may be measured. In an example, spectral roll-off may be useful in characterizing the shape of a frequency spectrum, which may be useful in determining user activity if combined with other measurements.

Particular examples of extraction of features characterizing a spectral envelope of an inertial sensor are provided below. Here, we denote the accelerometer readings for the x axis over a N sample window by aₓ(0), . . . , aₓ(N−1). For simplicity, the discussion below focuses on extracting features from inertial sensor signals responsive to movement along an x-axis. Here, it should be understood that features may be similarly extracted from accelerometer traces responsive to movement along other linear dimensions (e.g., along a y-axis and/or z-axis) in addition to, or in lieu of, accelerometer traces responsive to movement along an x-axis (e.g., for use in characterizing a user activity). Features may similarly be extracted from functions of the inertial sensor signals in the three linear dimensions, for example, an expression that may be used to track a magnitude signal may include:

$$\sqrt{{[ {a}_{x} ( 0 ) ]}^{2} + {[ {a}_{y} ( 0 ) ]}^{2} + {[ {a}_{z} ( 0 ) ]}^{2}} , … , \sqrt{{[ {a}_{x} ( N - 1 ) ]}^{2} + {[ {a}_{y} ( N - 1 ) ]}^{2} + {[ {a}_{z} ( N - 1 ) ]}^{2}}$$

For extraction of features such as CCs and/or MFCCs, for any particular accelerometer axis (e.g., for each such accelerometer axis) a set of N, Mel-frequency Cepstral coefficients may be computed. For an x-axis, for example, these may be denoted as cₓ(0), . . . , cₓ(N_{c}−1). Along with similar coefficients computed for y and z-axes, this would collectively yield 3/\/, features. In particular situations, these features may be correlated between axes. In a particular implementation, a set of N_{c} Mel-frequency Cepstral coefficients may be roughly computed by taking an Inverse Discrete Fourier Transform of the logarithm of the magnitude of the short-duration Fourier transforms of each of the accelerometer traces aₓ(n), a_{y}(n), and a_{z}(n) responsive to movement along the x, y and z dimensions, respectively. One difference between computing CCs vs. MFCCs, is in the frequency band pre-emphasis, in which higher frequency bands are deemphasized relative to lower frequency bands as described below for a particular implementation.

In a particular example implementation, the N_{c} MFCCs may be computed as follows:

1. Compute an N′-point discrete Fourier transform by zero padding the N-point accelerometer input.

$${A}_{x} ( k ) = {\sum }_{n = 0}^{N - 1} {a}_{x} ( n ) \text{?} \text{?} , f = 0 , 1 , … , N \text{?} - 1.$$

$$\text{?} \text{indicates text missing or illegible when filed}$$

In general, N′=KN, with K>>1, e.g. N′= [symbol] 16N.

2. Compute the center frequency indices of N filterbanks k [symbol] , . . . , k_{M-1}, spaced according to the Mel-frequency pre-emphasis, i.e.

k^{t}=α(10^{β} [symbol] −1) for [symbol] =0, . . . , M−1

where α and β are chosen appropriately.
For CCs (i.e. without the Mel-frequency pre-emphasis), set k [symbol] =γ [symbol] for [symbol] =0, . . . , M−1 where γ is chosen appropriately.

3. Compute the output coefficients of M filterbanks

$$\text{?} ( \text{?} ) = \text{?} {H}_{t} ( \text{?} ) log \vert {A}_{x} ( k ) \vert , \text{?} = 0 , … , M - 1$$

$$\text{?} \text{indicates text missing or illegible when filed}$$

where Hₜ(k) are triangular window functions, as follows

$${H}_{t} ( k ) = \{ \begin{matrix}\frac{k - {k}_{t - 1}}{{k}_{t} - {k}_{t - 1}} & {k}_{t - 1} \leq k \leq {k}_{i} \\ \frac{{k}_{t + 1} - k}{{k}_{t + 1} - {k}_{t}} & {k}_{t} \leq k \leq k \text{?} \\ 0 & otherwise\end{matrix} \\ \text{?} \text{indicates text missing or illegible when filed}$$

4. Compute the MFCCs

$$\text{?} ( n ) = \frac{2}{N \text{?}} {\sum }_{t = 1}^{M} \text{?} ( \text{?} ) co \text{?} ( \frac{2 π {k}_{t} n}{N \text{?}} ) , n = 0 , … , N \text{?} - 1$$

$$\text{?} \text{indicates text missing or illegible when filed}$$

The first coefficient may represent the log energy. This computation may be equivalent to taking the Inverse Discrete Fourier Transform (IDFT) of the sequence

$$\text{?} ( \text{?} ) = \text{?} \begin{matrix}\text{?} ) & If k = {k}_{t} \\ 0 & otherwise\end{matrix}$$

$$\text{?} \text{indicates text missing or illegible when filed}$$

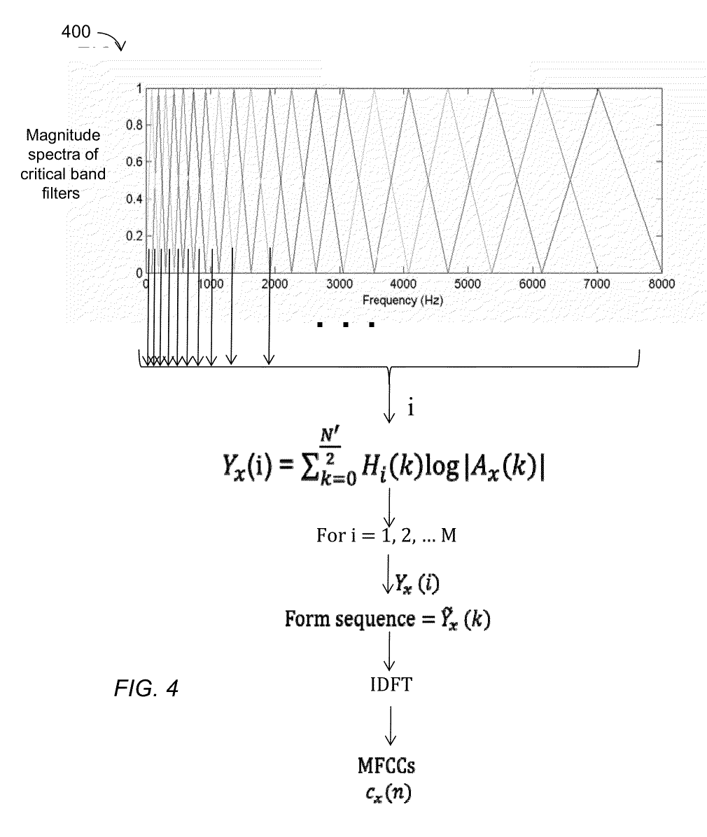

as illustrated in FIG. 4 (400). Typically N_{c}=13 CCs or MFCCs are computed. Further, in an implementation, the time base of FIG. 4 may be adjusted to correspond more closely to frequencies of interest of output signals of inertial sensors, which may be measured in the tens or hundreds of Hz, as opposed to the kHz time base of FIG. 4.

Again, as pointed out above, the same computation may be applied to accelerometer traces in they and z-axes for obtaining associated N, MFCCs.

For the example of FIG. 2 (200), MFCC's may be computed for plot 220 that may represent an output trace of an accelerometer on a mobile device being carried in a user's hand. For the example plot 220, values for MFCC numbers 1-4 are expressed in Table 1, below:

TABLE 1

| MFCC | Axis | | |
|---|---|---|---|
| No. | X | Y | Z |
| 1 | 12.3 | 12.3 | 9.4 |
| 2 | 7.9 | 7.9 | 7.2 |
| 3 | 2.7 | 1.9 | 1.8 |
| 4 | 1.5 | 0.1 | 0.2 |

For the example of FIG. 3 (250), MFCC's may be computed for plot 270 that may represent an output trace of an accelerometer on a mobile device being carried in a user's hip pocket. For the example plot 270, values for MFCC numbers 1-4 are expressed in Table 2, below:

TABLE 2

| MFCC | Axis | | |
|---|---|---|---|
| No. | X | Y | Z |
| 1 | 11.5 | 13.0 | 12.4 |
| 2 | 4.5 | 5.2 | 4.4 |
| 3 | 0.5 | −0.9 | −.05 |
| 4 | −0.6 | 0.5 | 0.8 |

Regarding computation of delta Cepstral coefficients, delta MFCCs, accel Cepstral coefficients and accel MFCCs, we denote a first window of x-axis accelerometer values by aₓ(0), . . . , aₓ(N−1), and their CCs or MFCCs by c_{x,l}(0), . . . , c_{x,l}(Nc−1). We also denote second window of x-axis accelerometer values by aₓ(F), . . . , aₓ(F+N−1), and their CCs or MFCCs by c_{x,2}(0), . . . , c_{x,2}(N_{c}−1). Here F represents the offset of the second window from the first. If F=N, there may be no overlap, if F=N/2 there may be 50% overlap. Similarly, the third window of x-axis accelerometer values by aₓ(2F), . . . aₓ(2F+N−1), and their CCs or MFCCs by c_{x,3}(0), . . . , c_{x,3}(N_{c}−1).

The delta CCs or MFCCs for the second window can then be computed as:

Δc_{x,} [symbol] ( [symbol] )=c_{x,} [symbol] (n)−c_{x,} [symbol] (n), for n=0, . . . , N [symbol] −1

Similarly the delta CCs or MFCCs for the third window can then be computed as follows:

Δc_{x,} [symbol] (n) [symbol] =c_{x,} [symbol] (n)−c_{x,} [symbol] (n) [symbol] , for n=0, . . . , N_{c}−1

The accel CCs or MFCCs for the third window can then be computed as:

Δ²c_{x,} [symbol] (n) [symbol] =Δc_{x,s}(n)−Δc_{x,} [symbol] (n)=2c_{x,} [symbol] +c_{x,} [symbol] (n), for n=0, . . . , N_{c}−1

CCs or MFCCs may be computed similarly for fourth and fifth windows, etc.

In a particular implementation, a spectral entropy may be computed as follows:

1. Compute an N-point discrete Fourier transform as:

$${A}_{x} ( k ) = {\sum }_{n = 0}^{N - 1} {a}_{x} ( n ) \text{?} \text{?}$$

$$\text{?} \text{indicates text missing or illegible when filed}$$

2. Normalize the computed N-point discrete Fourier transform as:

$$\overline{{A}_{x}} ( k ) - \frac{{A}_{x} ( k )}{\text{?} {A}_{x} ( n )}$$

$$\text{?} \text{indicates text missing or illegible when filed}$$

3. Represent the spectral entropy as:

$$\text{?} \text{?} = - \text{?} \overline{{A}_{x}} ( k ) {log}_{2} \overline{{A}_{x}} ( k )$$

$$\text{?} \text{indicates text missing or illegible when filed}$$

As pointed out above, features extracted from a sensor signal using techniques discussed herein may form feature vectors for processing by a classifier or classification engine to infer a particular user activity and/or to infer a position of a mobile device with respect to a user engaged in an activity. For example, joint statistics of the above-described features may be modeled with a Gaussian Mixture Model (GMM) and used in a Full Bayesian classifier. Alterntively, a particular single extracted feature may be treated independently with its statistics being modeled by a GMM and used in a Naive Bayesian classifier. In other implementations, dependencies between or among some subsets of features may be modeled, while treating other subsets as independent.

In particular, implementations, a classifier may be trained over time. For every three seconds of accelerometer data, in a particular example implementation, 150 samples per axis (sampling freq.=50 Hz), for a total of 450 samples may be gathered, which we call x as follows:

x={aₓ(1), . . . , aₓ(150),a_{y}(1), . . . , a_{y}(150),a_{z}(1), . . . , a_{z}(150)}.

From these samples (x), a feature vector f(x) may be computed. In the particular example below, there are two features f1 and f2, so this feature vector has two dimensions as follows:

f(x)=[f1(x)],[f2(x)].

In a particular implementation, these two dimensions may correspond to computing, for example, a pitch, and average magnitude of acceleration.

FIG. 5 is a plot illustrating the decision regions that are formed as a result of training a classifier according to an implementation. To train a classifier, data may be collected for each of a plurality of predefined activity classifications. In a particular example, there may be the following three predefined activity classifications: 1) walking with device in hand, a class that may be denoted as ω₁, 2) walking with device in pocket, a class that may be denoted as ω₂, and 3) running with device in pocket, a class that may be denoted as ω₃. Data in the two-dimension feature space may be plotted as shown in FIG. 5, for a particular example. A statistical model may be trained for each predefined class which assigns for every point x in the 2-D space, a probability of the point x being generated by the statistical model for that class, which may be referred to as a likelihood function. These likelihood functions may be denoted P(f(x)|ω=ω₁), P(f(x)|ω=ω₂), and P(f(x)|ω=ω₃), for the aforementioned three predefined activity classes. Note that each likelihood function takes two features, f1(x) and f2(x), as inputs and provides a single probability value (a number between 0 and 1).

After training (e.g., during real-time operation) a classifier may receive as input, an unknown data point x (e.g., the aforementioned 450 accelerometer samples), and compute a corresponding feature vector for that data point f(x). The classifier may then select an activity classification having the highest likelihood for that point x, for example as expressed as follows:

\hat{ω}=argmaxωkε_{{}ω1,ω2,ω3}P(f(x)|ωk)

The expression above sets the output value \hat{ω} to ω1 (e.g., class 1=walking with device in hand) if the likelihood for class 1 is higher than that of class 2 and also higher than that of class 3, e.g., P(f(x)|ω₁)>P(f(x)|ω₂) and P(f(x)|ω₁)>P(f(x)|ω₃). Likewise class 2 is chosen if it has a higher likelihood than class 1 and class 3, and likewise class 3 is chosen if its likelihood is highest. Pictorially this is illustrated in FIG. 5 in a 2-D feature space (x-axis=f1, y-axis=f2). Sets of points in decision region 1, decision region 2, and decision region 3 represent training data for a particular example. Based, at least in part, on the training data, one or more statistical models may be formulated or generated. These models may characterize class 1 (set of points 10) being chosen if a real-time data point x lands in decision region 1 (as this is the region for which P(f(x)|ω₁) is greater than both P(f(x)|ω₂) and P(f(x)|ω₃). Likewise class 2 may be chosen if a real-time data point x lands in decision region 2, and class 3 may be chosen if a real-time data point x lands in decision region 3.

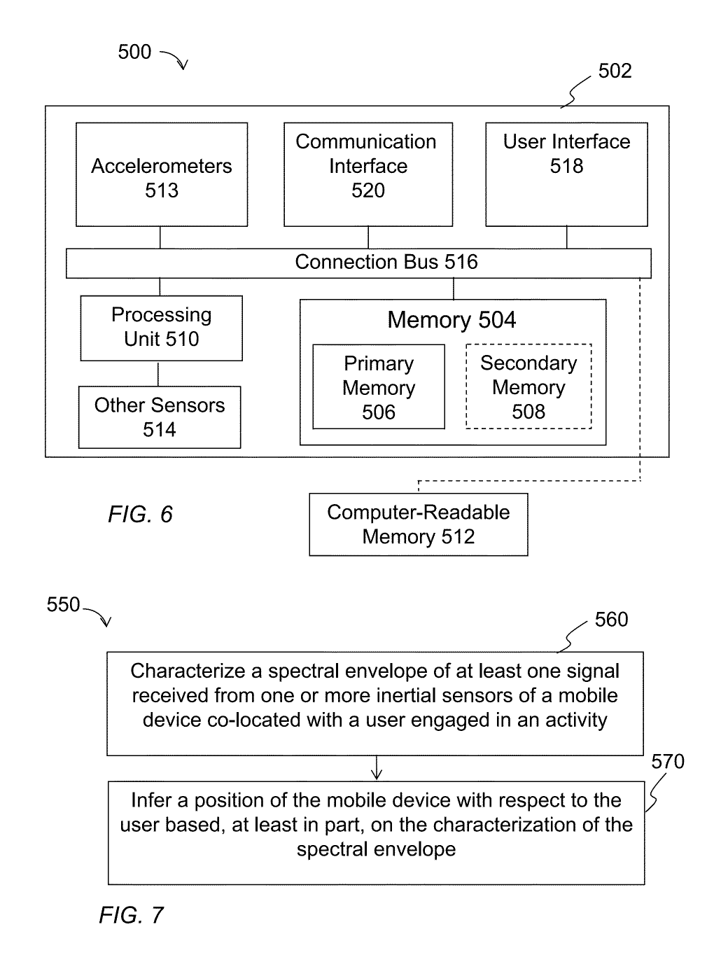

FIG. 6 is a schematic diagram illustrating an implementation of an example computing environment 500 that may include one or more networks or devices capable of partially or substantially implementing or supporting one or more processes for classifying an activity of a user co-located with a mobile device based, at least in part, inertial sensor signals. It should be appreciated that all or part of various devices or networks shown in computing environment 500, processes, or methods, as described herein, may be implemented using various hardware, firmware, or any combination thereof along with software.

Computing environment 500 may include, for example, a mobile device 502, which may be communicatively coupled to any number of other devices, mobile or otherwise, via a suitable communications network, such as a cellular telephone network, the Internet, mobile ad-hoc network, wireless sensor network, or the like. In an implementation, mobile device 502 may be representative of any electronic device, appliance, or machine that may be capable of exchanging information over any suitable communications network. For example, mobile device 502 may include one or more computing devices or platforms associated with, for example, cellular telephones, satellite telephones, smart telephones, personal digital assistants (PDAs), laptop computers, personal entertainment systems, e-book readers, tablet personal computers (PC), personal audio or video devices, personal navigation devices, or the like. In certain example implementations, mobile device 502 may take the form of one or more integrated circuits, circuit boards, or the like that may be operatively enabled for use in another device. Although not shown, optionally or alternatively, there may be additional devices, mobile or otherwise, communicatively coupled to mobile device 502 to facilitate or otherwise support 1 or more processes associated with computing environment 500. Thus, unless stated otherwise, to simplify discussion, various functionalities, elements, components, etc. are described below with reference to mobile device 502 may also be applicable to other devices not shown so as to support one or more processes associated with example computing environment 500.

Computing environment 500 may include, for example, various computing or communication resources capable of providing position or location information with regard to a mobile device 502 based, at least in part, on one or more wireless signals associated with a positioning system, location-based service, or the like. Although not shown, in certain example implementations, mobile device 502 may include, for example, a location-aware or tracking unit capable of acquiring or providing all or part of orientation, position information (e.g., via trilateration, heat map signature matching, etc.), etc. Such information may be provided in support of one or more processes in response to user instructions, motion-controlled or otherwise, which may be stored in memory 504, for example, along with other suitable or desired information, such as one or more threshold values, or the like.

Memory 504 may represent any suitable or desired information storage medium. For example, memory 504 may include a primary memory 506 and a secondary memory 508. Primary memory 506 may include, for example, a random access memory, read only memory, etc. While illustrated in this example as being separate from a processing unit 510, it should be appreciated that all or part of primary memory 506 may be provided within or otherwise co-located/coupled with processing unit 510. Secondary memory 508 may include, for example, the same or similar type of memory as primary memory or one or more information storage devices or systems, such as, for example, a disk drive, an optical disc drive, a tape drive, a solid state memory drive, etc. In certain implementations, secondary memory 508 may be operatively receptive of, or otherwise enabled to be coupled to, a non-transitory computer-readable medium 512.

Computer-readable medium 512 may include, for example, any medium that can store or provide access to information, code or instructions (e.g., an article of manufacture, etc.) for one or more devices associated with computing environment 500. For example, computer-readable medium 512 may be provided or accessed by processing unit 510. As such, in certain example implementations, the methods or apparatuses may take the form, in whole or part, of a computer-readable medium that may include computer-implementable instructions stored thereon, which, if executed by at least one processing unit or other like circuitry, may enable processing unit 510 or the other like circuitry to perform all or portions of a position determination processes, sensor-based or sensor-supported measurements (e.g., acceleration, deceleration, orientation, tilt, rotation, etc.), extraction/computation of features from inertial sensor signals, classifying an activity co-located with a user of mobile device, or any like processes to facilitate or otherwise support rest detection of mobile device 502. In certain example implementations, processing unit 510 may be capable of performing or supporting other functions, such as communications, gaming, or the like.

Processing unit 510 may be implemented in hardware or a combination of hardware and software. Processing unit 510 may be representative of one or more circuits capable of performing at least a portion of information computing technique or process. By way of example but not limitation, processing unit 510 may include one or more processors, controllers, microprocessors, microcontrollers, application specific integrated circuits, digital signal processors, programmable logic devices, field programmable gate arrays, or the like, or any combination thereof.

Mobile device 502 may include various components or circuitry, such as, for example, one or more accelerometers 513, or various other sensor(s) 514, such as a magnetic compass, a gyroscope, a video sensor, a gravitometer, etc. to facilitate or otherwise support one or more processes associated with computing environment 500. For example, such sensors may provide analog or digital signals to processing unit 510. Although not shown, it should be noted that mobile device 502 may include an analog-to-digital converter (ADC) for digitizing analog signals from one or more sensors. Optionally or alternatively, such sensors may include a designated (e.g., an internal, etc.) ADC(s) to digitize respective output signals, although claimed subject matter is not so limited.

Although not shown, mobile device 502 may also include a memory or information buffer to collect suitable or desired information, such as, for example, accelerometer measurement information (e.g., accelerometer traces), as previously mentioned. Mobile device may also include a power source, for example, to provide power to some or all of the components or circuitry of mobile device 502. A power source may be a portable power source, such as a battery, for example, or may comprise a fixed power source, such as an outlet (e.g. in a house, electric charging station, etc.). It should be appreciated that a power source may be integrated into (e.g., built-in, etc.) or otherwise supported by (e.g., stand-alone, etc.) mobile device 502.

Mobile device 502 may include one or more connection bus 516 (e.g., buses, lines, conductors, optic fibers, etc.) to operatively couple various circuits together, and a user interface 518 (e.g., display, touch screen, keypad, buttons, knobs, microphone, speaker, trackball, data port, etc.) to receive user input, facilitate or support sensor-related signal measurements, or provide information to a user. Mobile device 502 may further include a communication interface 520 (e.g., wireless transmitter or receiver, modem, antenna, etc.) to allow for communication with one or more other devices or systems over one or more suitable communications networks, as was indicated.

FIG. 7 is a flow chart (550) illustrating a process of inferring a position state of a mobile device with respect to a user engaged in an activity according to an implementation (where a position state refers to the classification of the position rather than an absolute position such as that computed by GPS or other positioning techniques). Although the embodiment of FIG. 6 may be suitable for performing the method of FIG. 7, nothing prevents performing the method using alternative arrangements of structures and components. In an implementation, it is envisioned that a user will be engaged in some form of movement with rhythmic behavior such as walking, running, cycling and so on, during the application of the method, although claimed subject matter is not limited in this respect.

The method of FIG. 7 begins at block 560 in which a spectral envelope of at least one signal received from one or more inertial sensors of a mobile device co-located with a user engaged in an activity is characterized. At block 570, a position state of a mobile device with respect to the user based, at least in part, on the characterization of the spectral envelope is inferred.

Methodologies described herein may be implemented by various means depending upon applications according to particular features or examples. For example, such methodologies may be implemented in hardware, firmware, software, discrete/fixed logic circuitry, any combination thereof, and so forth. In a hardware or logic circuitry implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices or units designed to perform the functions described herein, or combinations thereof, just to name a few examples.

For a firmware or software implementation, the methodologies may be implemented with modules (e.g., procedures, functions, etc.) having instructions that perform the functions described herein. Any machine-readable medium tangibly embodying instructions may be used in implementing the methodologies described herein. For example, software codes may be stored in a memory and executed by a processor. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored. In at least some implementations, one or more portions of the herein described storage media may store signals representative of data or information as expressed by a particular state of the storage media. For example, an electronic signal representative of data or information may be “stored” in a portion of the storage media (e.g., memory) by affecting or changing the state of such portions of the storage media to represent data or information as binary information (e.g., ones and zeros). As such, in a particular implementation, such a change of state of the portion of the storage media to store a signal representative of data or information constitutes a transformation of storage media to a different state or thing.

As was indicated, in one or more example implementations, the functions described may be implemented in hardware, software, firmware, discrete/fixed logic circuitry, some combination thereof, and so forth. If implemented in software, the functions may be stored on a physical computer-readable medium as one or more instructions or code. Computer-readable media include physical computer storage media. A storage medium may be any available physical medium that can be accessed by a computer. By way of example, and not limitation, such computer-readable media can comprise RAM, ROM, EEPROM, CD-ROM or other optical disc storage, magnetic disk storage or other magnetic storage devices, or any other medium that can be used to store desired program code in the form of instructions or data structures and that can be accessed by a computer or processor thereof. Disk and disc, as used herein, includes compact disc (CD), laser disc, optical disc, digital versatile disc (DVD), floppy disk and blue-ray disc where disks usually reproduce data magnetically, while discs reproduce data optically with lasers.

As discussed above, a mobile device may be capable of communicating with one or more other devices via wireless transmission or receipt of information over various communications networks using one or more wireless communication techniques. Here, for example, wireless communication techniques may be implemented using a wireless wide area network (WWAN), a wireless local area network (WLAN), a wireless personal area network (WPAN), or the like. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as cdma2000, Wideband-CDMA (WCDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, or some other type of network, for example. The techniques may also be implemented in conjunction with any combination of WWAN, WLAN, or WPAN. Wireless communication networks may include so-called next generation technologies (e.g., “4G”), such as, for example, Long Term Evolution (LTE), Advanced LTE, WiMAX, Ultra Mobile Broadband (UMB), or the like.

In one particular implementation, a mobile device may, for example, be capable of communicating with one or more femtocells facilitating or supporting communications with the mobile device for the purpose of estimating its location, orientation, velocity, acceleration, or the like. As used herein, “femtocell” may refer to one or more smaller-size cellular base stations that may be enabled to connect to a service provider's network, for example, via broadband, such as, for example, a Digital Subscriber Line (DSL) or cable. Typically, although not necessarily, a femtocell may utilize or otherwise be compatible with various types of communication technology such as, for example, Universal Mobile Telecommunications System (UTMS), Long Term Evolution (LTE), Evolution-Data Optimized or Evolution-Data only (EV-DO), GSM, Worldwide Interoperability for Microwave Access (WiMAX), Code division multiple access (CDMA)-2000, or Time Division Synchronous Code Division Multiple Access (TD-SCDMA), to name just a few examples among many possible. In certain implementations, a femtocell may comprise integrated WiFi, for example. However, such details relating to femtocells are merely examples, and claimed subject matter is not so limited.

Also, computer-readable code or instructions may be transmitted via signals over physical transmission media from a transmitter to a receiver (e.g., via electrical digital signals). For example, software may be transmitted from a website, server, or other remote source using a coaxial cable, fiber optic cable, twisted pair, digital subscriber line (DSL), or physical components of wireless technologies such as infrared, radio, and microwave. Combinations of the above may also be included Within the scope of physical transmission media. Such computer instructions or data may be transmitted in portions (e.g., first and second portions) at different times (e.g., at first and second times). Some portions of this Detailed Description are presented in terms of algorithms or symbolic representations of operations on binary digital signals stored within a memory of a specific apparatus or special purpose computing device or platform. In the context of this particular Specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures or characteristics. However, it should be noted that this is merely an illustrative example and claimed subject matter is not limited to this example.

While certain example techniques have been described and shown herein using various methods or systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

What is claimed is:

1. A method comprising:
determining one or more parameters characterizing a spectral envelope of at least one signal received from one or more inertial sensors of a mobile device co-located with a user engaged in an activity; and
inferring a position state of said mobile device based, at least in part, on said characterization of said spectral envelope.

2. The method of claim 1, wherein inferring said position state comprises inferring said position state from a plurality of candidate position states using a Bayesian classifier.

3. The method of claim 1, wherein inferring said position state comprises inferring said position state from a plurality of candidate position states with respect to a user comprising at least one of:
being in said user's hand,
being fastened to said user's wrist or arm while said user is walking, running, or riding a bicycle,
being in said user's shirt or coat pocket while said user is walking, running, or riding a bicycle or a motorcycle,
being in said user's pants pocket while said user is walking, running, or riding a bicycle,
being in a holster attached to said user's belt or clothing,
being in a bag, suitcase, or briefcase carried or wheeled by said user, and
being in an automobile, a bus, or a train.

4. The method of claim 3, further comprising:
inferring that said user is walking with said mobile device in said user's hand based, at least in part, on detecting acceleration of said mobile device in one direction, said acceleration in said one direction being greater than acceleration in at least second and third directions.

5. The method of claim 3, further comprising:
inferring that said user is walking with said mobile device in said user's pocket based, at least in part, on detecting acceleration peaks in a first direction, said acceleration peaks being greater than acceleration peaks in second and third directions.

6. The method of claim 1, wherein said determining one or more parameters characterizing a spectral envelope further comprises:
computing Cepstral Coefficients based, at least in part, on said at least one signal.

7. The method of claim 1, wherein said determining one or more parameters characterizing a spectral envelope comprises performing one or more computations selected from the group consisting of:
computing Mel-Frequency Cepstral Coefficients, computing delta Cepstral Coefficients, computing delta Mel-Frequency Cepstral Coefficients, computing accel Cepstral Coefficients, computing accel Mel-Frequency Cepstral Coefficients, computing Linear Prediction Coefficients, computing delta Linear Prediction coefficients, and computing accel linear prediction coefficients,
based, at least in part, on said at least one signal.

8. The method of claim 1, further comprising:
measuring a pitch of said at least one signal; and
inferring said position state based, at least in part, on said measured pitch.

9. The method of claim 1, and further comprising:
measuring a spectral entropy of said at least one signal; and
inferring said position state based, at least in part, on said measured spectral entropy.

10. The method of claim 1, and further comprising:
measuring a zero crossing rate of said at least one signal; and
inferring said position state based, at least in part, on said measured Zero Crossing Rate.

11. The method of claim 1, and further comprising:
measuring spectral centroid of said at least one signal; and
inferring said position state based, at least in part, on said measured spectral centroid.

12. The method of claim 1, and further comprising:
measuring a bandwidth of said at least one signal; and
inferring said position state based, at least in part, on said measured bandwidth.

13. The method of claim 1, and further comprising:
measuring band energies of said at least one signal; and
inferring said position state based, at least in part, on said measured band energies.

14. The method of claim 1, and further comprising:
measuring a spectral flux of said at least one signal; and
inferring said position state based, at least in part, on said measured spectral flux.

15. The method of claim 1, and further comprising:
measuring a spectral roll-off of said at least one signal; and
inferring said position state based, at least in part, on said measured spectral roll-off.

16. An apparatus comprising:
means for sensing movement of a mobile device;
means for characterizing a spectral envelope of at least one signal received from said means for sensing movement; and
means for inferring a position state of said mobile device with respect to said user based, at least in part, on said characterization of said spectral envelope.

17. The apparatus of claim 16, further comprising means for inferring an activity of the user based, at least in part, on said characterization of said spectral envelope.

18. The apparatus of claim 17, wherein said means for characterizing further comprises:
means for computing Cepstral Coefficients based, at least in part, on said at least one signal.

19. An article comprising:
a non-transitory storage medium comprising machine-readable instructions stored thereon which are executable by a processor of a mobile device to:
characterize a spectral envelope of at least one signal received from one or more inertial sensors of a mobile device; and
infer a position state of said mobile device with respect to said user engaged in an activity based, at least in part, on said characterization of said spectral envelope.

20. A mobile device comprising:
one or more inertial sensors for measuring motion of said mobile device: and
one or more processors to:
characterize a spectral envelope of at least one signal received from said one or more inertial sensors; and
infer a position state of said mobile device with respect to said user engaged in an activity based, at least in part, on said characterizing of said spectral envelope.

21. The mobile device of claim 20, wherein said one or more processors further infers said position state of said mobile device with respect to said user from a plurality of candidate position states with respect to said user comprising at least one of:
being in said user's hand, being fastened to said user's wrist or arm, being in said user's shirt, coat, or pants pocket, or being in said user's bag while said user is engaged in an activity.

22. The mobile device of claim 21, wherein said one or more processors further classifies said activity from a plurality of candidate activities consisting of: walking, running, riding a bicycle, and riding in an automobile, riding in a bus, riding in a train, or riding on a motorcycle.

23. The mobile device of claim 21, wherein said one or more processors further computes Cepstral Coefficients based, at least in part, on said at least one signal.
